(19) United States
(12) Patent Application Publication
(10) Pub. No.: US 2005/0275382 A1
(43) Pub. Date: Dec. 15, 2005

(54) Charge consumption monitor for electronic device

(76) Inventors: Nicholas J. Stessman, Minneapolis, MN (US); Keith R. Maile, New Brighton, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/864,753

(22) Filed: Jun. 9, 2004

(51) Int. Cl. H02J 7/04

(52) U.S. Cl. 320/143

(57) ABSTRACT

A charge consumption measuring circuit is disclosed which is particularly suitable for use in an implantable cardiac device. The circuit utilizes the power conversion cycles of an inductive switching regulator to measure the quantity of charge supplied by a battery and/or drawn by the circuitry of the device.

### FIELD OF THE INVENTION

This invention pertains to systems and methods for operating battery-powered implantable medical devices.

### BACKGROUND

In many battery-operated electronic devices, it is desirable to be able to predict the amount of operating time remaining throughout the life (or charge cycle) of the battery. Cardiac rhythm management devices, for example, are implantable cardiac devices that provide electrical stimulation to selected chambers of the heart in order to treat disorders of cardiac rhythm and include pacemakers and implantable cardioverter/defibrillators (ICDs). These implantable cardiac devices are powered by a battery contained within the housing of the device that has a limited life span. When the battery fails, the device must be replaced which necessitates a re-implantation procedure. The useful life of the battery may vary in each individual case and depends upon the specific battery and the power requirements of the device. For example, a device which must deliver paces and/or defibrillation shocks on a frequent basis will shorten the useful life of the battery. As the battery depletes, it is desirable to provide a means of determining that the battery is near the end of its life so that replacement of the battery can be scheduled rather than done on an emergency basis.

For most battery technologies, one can predict how much operating time is remaining if the remaining charge capacity of the battery and the rate of charge consumption (i.e., current draw) imposed by the battery's load (i.e., the electronic circuitry of the device) can be determined. The remaining charge capacity of the battery can be determined by subtracting the total charge drawn from the battery up to that point from the initial charge capacity of the battery. The rate of charge consumption can be determined by examining the amount of charge drawn from the battery over a known time interval. Since it is fairly common for electronic devices to incorporate a crystal timebase, a known time interval is readily available. The only remaining task is to monitor the charge consumption of the battery. In some applications, it is possible to measure battery charge consumption by inserting a sense resistor in series with one of the battery terminals, measuring the voltage drop across the sense resistor, and integrating the voltage measurement over time. This technique is most appropriate when the ratio of the peak battery current to average battery current is kept reasonably low (e.g., less than 50). In other applications where this ratio is much higher due to power supplies operating in a burst fashion, this technique is problematic. For these applications, alternative methods of measuring charge consumption must be employed. This present disclosure relates to a system and method for measuring the charge consumption in a battery-powered device which utilizes an inductive switching regulator.

### BRIEF DESCRIPTION OF THE DRAWINGS

FIG. 1 shows the basic components of an implantable cardiac device.

FIG. 2A illustrates a buck mode inductive switching regulator.

FIG. 2B illustrates the current flows of a buck mode inductive switching regulator.

FIG. 3A illustrates a boost mode inductive switching regulator.

FIG. 3B illustrates the current flows of a boost mode inductive switching regulator.

FIG. 4A illustrates a buck-boost mode inductive switching regulator.

FIG. 4B illustrates the current flows of a buck-boost mode inductive switching regulator.

FIG. 5 illustrates a particular embodiment of a coulometer circuit.

### DETAILED DESCRIPTION

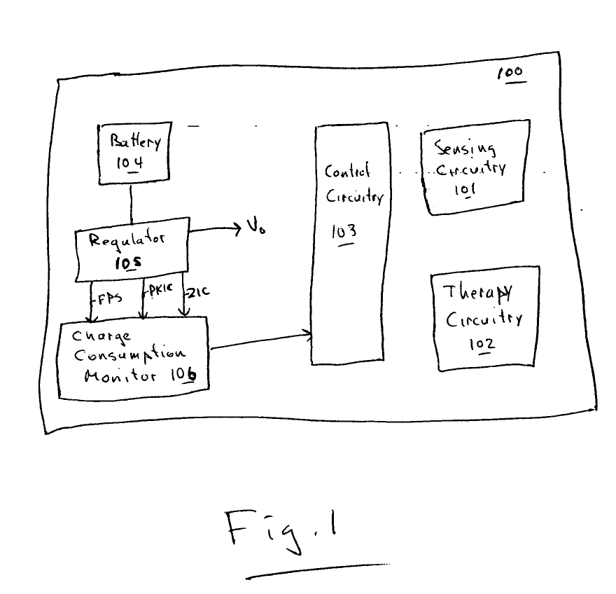

FIG. 1 illustrates the basic components of an implantable cardiac device 100 which are relevant to the present discussion. Sensing circuitry 101 receives electrogram signals from internal electrodes which reflect the electrical activity of the heart. Therapy circuitry 102 includes pulse generation circuitry for generating pacing pulses and/or defibrillation shocks which are delivered to the heart via internal electrodes. Control circuitry 103 interprets the electrogram signals and controls the output of electrical stimulation to heart as needed. The power supply for the device includes a battery 104 and an inductive switching regulator 105. The inductive switching regulator 105 is a DC-DC converter which provides a stable and appropriate voltage level to the electronic circuitry. A charge consumption monitor 106 measures charge consumption in the device, which may be the current supplied by the battery and/or the current drawn by the electronic circuitry. In various embodiments, the control circuitry and charge consumption monitor may be implemented by discrete component circuitry and/or a microprocessor-based controller executing coded instructions.

In one embodiment, the inductive switching voltage regulator alternately stores and discharges energy in an inductor in a two-phase power conversion cycle, the power conversion phases designated as fill and dump phases, respectively. The inductor current increases until a predetermined peak current value is reached during the fill phase and decreases to zero or other predetermined value during the dump phase. Advantage may be taken of this mechanism by which the inductor alternately stores and discharges energy in order to measure the charge consumption in the device. Since the inductor current increases or decreases linearly between two fixed values during a power conversion phase, the quantity of charge consumed will be proportional to the duration of the phase. In one embodiment, the charge consumption monitor 106 measures charge consumption as the duration of a power conversion phase during a power conversion cycle multiplied by one-half the peak inductor current. In order to calculate the quantity of charge consumed during a plurality of power conversion cycles, the cumulative duration of a power conversion phase over the plurality of power conversion cycles is multiplied by one-half the peak inductor current. The switching regulator 105 generates three signals which are asserted to indicate the start and end of the power conversion phases for use by the charge consumption monitor. These signals are: FPS which marks the start of the fill phase, PKIC which indicates that the inductor current has reached its predetermined peak value and therefore signifies the end of the fill phase and the start of the dump phase, and ZIC which indicates that the inductor current is zero and therefore signifies the end of the dump phase. The charge consumption measuring circuit 106 measures the time intervals between the assertions of selected ones of these signals in order to calculate charge consumption in the device. Depending upon which intervals are selected, the measured charge consumption may reflect the battery charge consumption (i.e., the current supplied by the battery), the output charge consumption (i.e., the current drawn by the device circuitry), or both. A more detailed explanation and descriptions of different embodiments are set forth below.

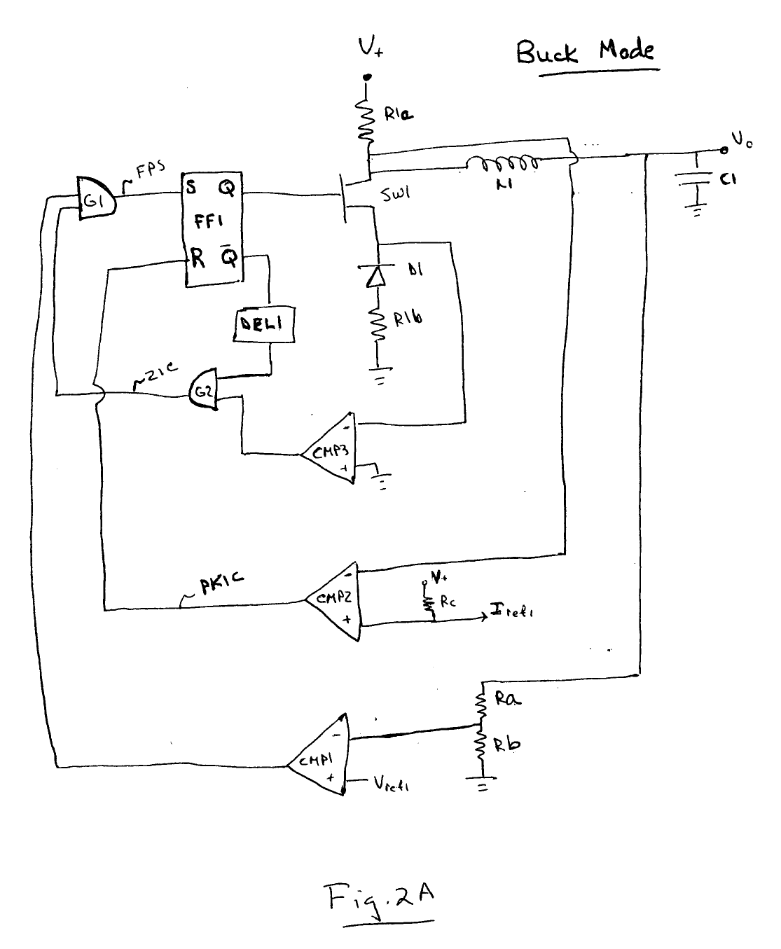

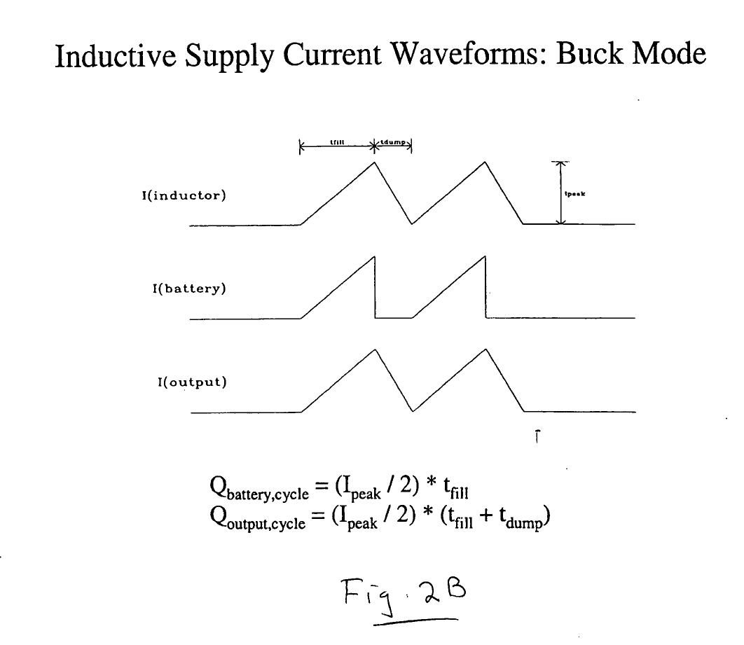

Typically, inductive switching supplies operate in one of three basic modes: buck, boost, or buck-boost. FIGS. 2A through 4A are examples of inductive switching regulator circuits, each of which operates in a different mode. These modes commonly utilize a two-phase power conversion cycle, where the two power conversion phases during which the inductor is charged and discharged are referred to herein as “fill” and “dump” phases, respectively. One way in which an inductive switching regulator may operate is in a synchronous fashion whereby circuitry monitors the inductor current during both power conversion phases such that the duration of each phase is controlled via feedback from the inductor current monitor. During the fill phase, the inductor current starts at zero and ramps up towards a predetermined peak current value. Once this peak current value is reached, the fill phase is terminated and the dump phase begins. During the dump phase, the inductor current starts off at the peak current value and ramps back down towards zero. When the inductor current reaches zero, the dump phase is terminated, and either a new cycle can begin again or charging can stop as determined by a feedback loop which compares the output voltage of the regulator with a reference voltage.

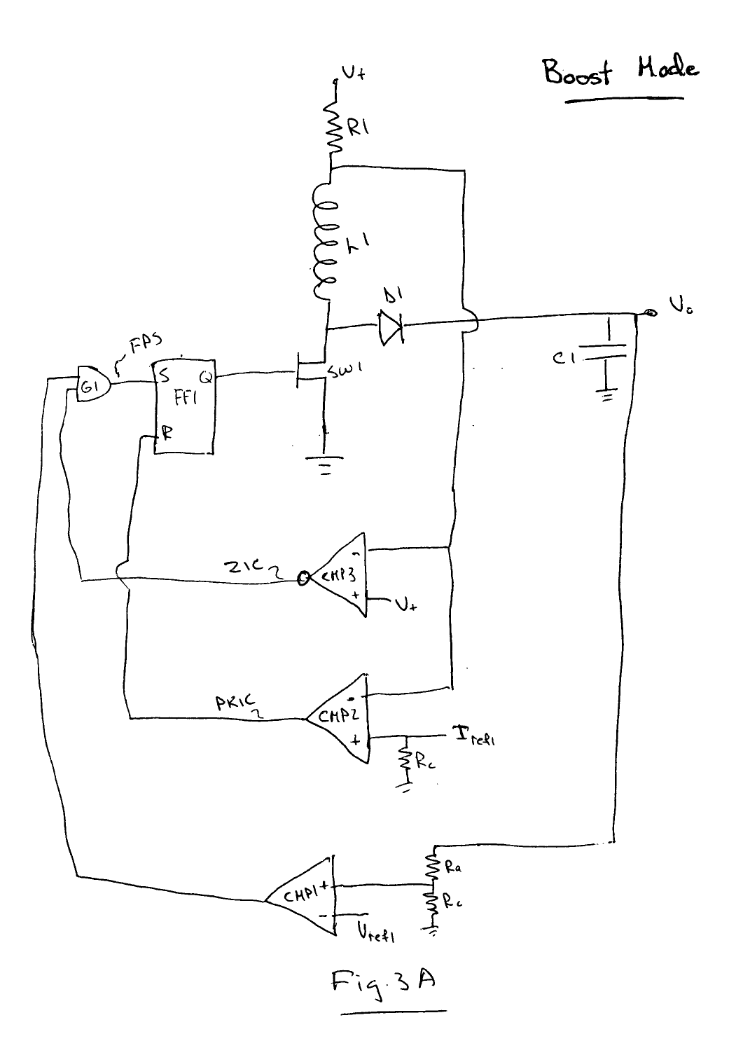

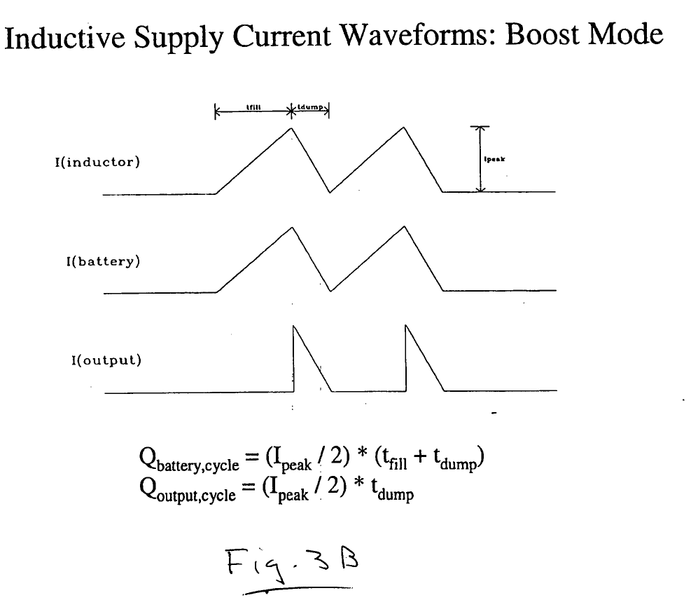

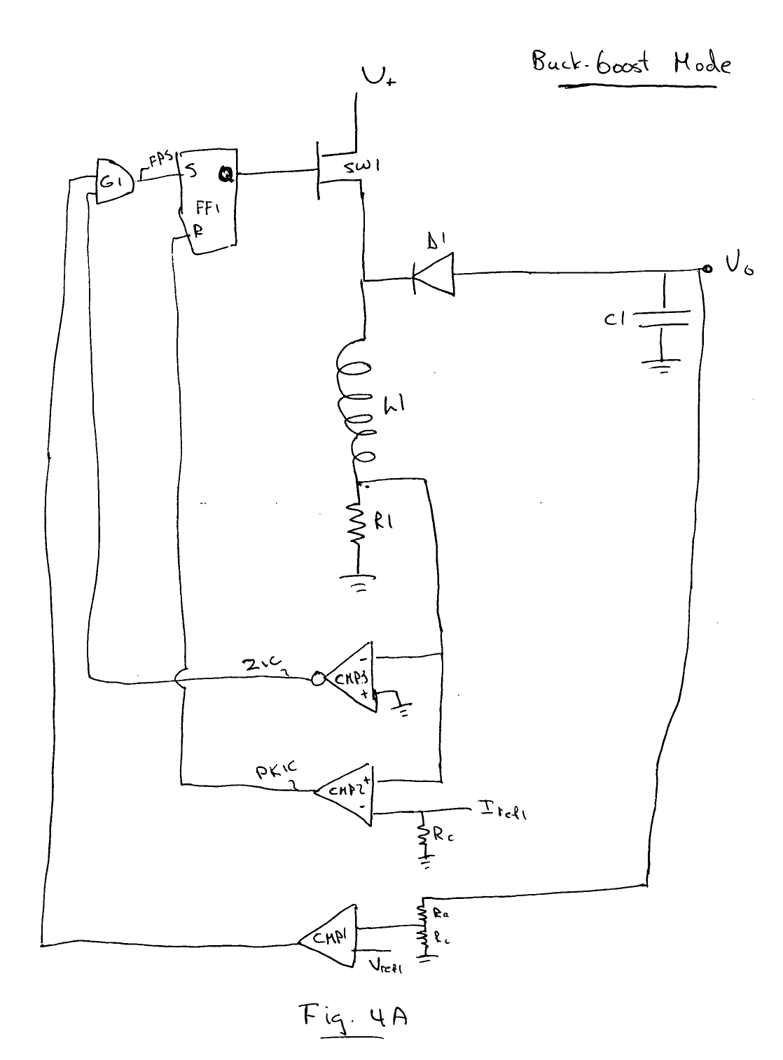

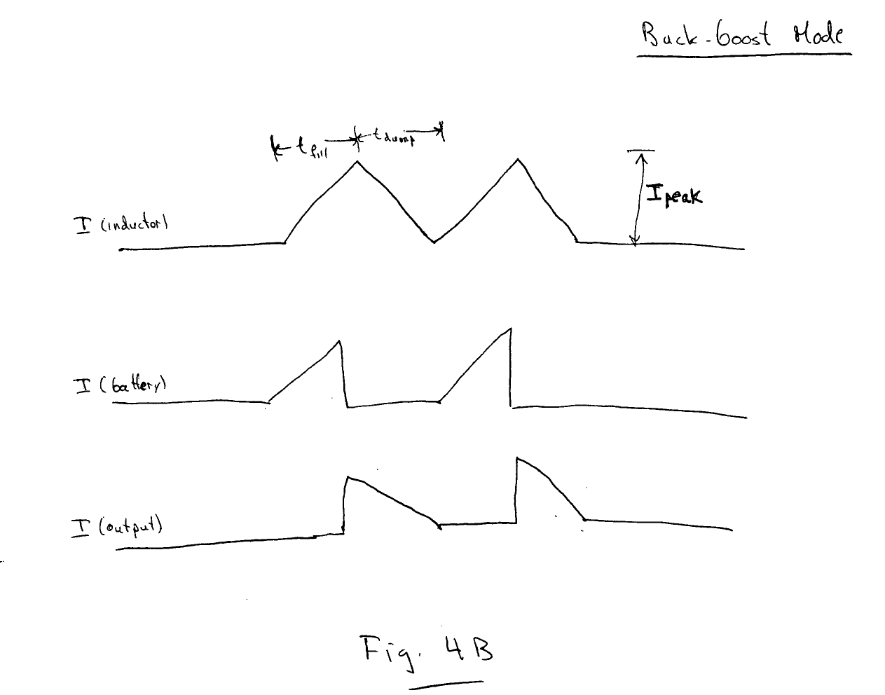

FIG. 2A is an example of a buck mode inductive switching regulator circuit. A MOS switch whose state is controlled by the output of flip-flop FF1 alternately switches the battery voltage V₊ across inductor L1 and capacitor C1, the capacitor voltage being the output voltage Vₒ of the regulator. When switch SW1 closes, the fill phase begins and the inductor current increases linearly, assuming a constant voltage across the inductor L1. When switch SW1 opens, the fill phase ends and the dump phase begins. During the dump phase, the voltage across L1 reverses polarity so as to maintain the flow of inductor current. The current through inductor L1 then flows through diode D1 in a linearly decreasing fashion, assuming a constant voltage across the inductor. The durations of the fill and dump phases are controlled by circuitry which monitors the inductor current. A portion of the output voltage Vₒ is fed back via a voltage divider made up of resistors Rₐ and R_{b} to a comparator CMP1 where it is compared with a reference voltage V_{ref1}. If the output voltage is low, so that the output of CMP1 is asserted, a power conversion cycle begins. The inductor current is measured with current sense resistors R1a and R1b whose voltages are fed to comparators CMP2 and CMP3, respectively. During the dump phase, the inverted output of comparator CMP3 is asserted when the inductor current is zero, as indicated by the assertion of AND gate G2 to give the signal ZIC. Comparator CMP3 must have a small negative input offset voltage to ensure that the ZIC signal is always asserted whenever the inductor current is zero. Also, delay element DEL1 and AND gate G2 ensure that the output of comparator CMP3 is only allowed to determine the state of signal ZIC when the output of comparator CMP3 is valid. These circuit elements thus form a zero current detector. The rising edge of signal ZIC signifies that the previous dump cycle has ended as the inductor current has decreased to zero. The outputs of gate G2 and comparator CMP1 are ANDed together by gate G1 to result in signal FPS which when asserted begins the fill phase by setting flip-flop FF1, the output of which then closes switch SW1. The fill phase continues until the inductor current, which flows through sense resistor R1a during the fill phase, reaches its predetermined peak value. The voltage across resistor R1a is compared with a voltage derived from a reference current I_{ref1} by comparator CMP2. The reference current I_{ref1} is dropped across a resistor Rc with the values of the reference current and resistor chosen such that the output PKIC of comparator CMP2 is asserted when the inductor current reaches its predetermined peak value. These circuit elements thus form a peak current detector. The assertion of PKIC resets the flip-flop FF1 and signifies the end of the fill phase and the beginning of the dump phase. In FIGS. 3A and 4A, the same components are rearranged to result in inductive switching regulators which operate in boost and buck-boost modes, respectively, the operations of which are similar to that of the buck mode just described. The start of the fill phase, end of the fill phase, and end of the dump phase are again indicated by assertions of the FPS, PKIC, and ZIC signals, respectively. (Note that only one current sense resistor R1 and one AND gate G1 are used to implement the inductor current monitor for the circuits of FIGS. 3A and 4A.) In the examples of inductive switching regulators illustrated by FIGS. 2A through 4A, energy is alternately charged and discharged in an inductor. Other embodiments of an inductive switching regulator may employ a transformer as the inductive element, and the term inductor as used herein should be taken to mean either a single-winding inductor or a transformer.

If the battery voltage and output voltage of an inductive switching regulator do not change significantly throughout either phase of an individual charging cycle, then the inductor current exhibits a fairly constant rate of change (dI/dt) during the fill and dump phases. That is, the inductor current changes linearly if the voltage across the inductor is constant. Furthermore, the net change in the inductor current is the same for both phases and is equal to the peak current value. If the durations of both phases can be measured, then the amount of charge that has flowed through the inductor during each phase can be calculated as follows:
Q_{fill}=(Iₚₑₐₖ/2)*t_{fill}
Q_{dump}=(Iₚₑₐₖ/2)*t_{dump}
For buck and buck-boost power conversion modes, the battery charge consumption over one charging cycle is simply Q_{fill} since the battery only supplies current during the fill phase. For boost mode power conversion, the battery supplies current during both phases and so the battery charge consumption over one charging cycle is equal to Q_{fill}+Q_{dump}. The output charge consumption can be determined in a similar manner. For buck mode power conversion, the output charge consumption over one charging cycle is equal to Q_{fill}+Q_{dump} since the output receives the inductor current during both phases. For buck-boost and boost mode power conversion, the output charge consumption over one charging cycle is simply Q_{dump} since the inductor current only flows into the output during the dump phase. FIGS. 2B, 3B, and 4B illustrate these different cases for the buck, boost, and buck-boost modes, respectively, by showing the inductor current, battery current, and output current during a power conversion cycle.

As mentioned above, for an inductive power supply in which the inductor current is monitored in such a way that a known peak current is achieved during the fill phase and the inductor current returns to zero during the dump phase, the battery or output charge consumption for each charging cycle can be determined directly from three quantities: the peak inductor current (Iₚₑₐₖ), the time duration of the fill phase (t_{fi11}), and the time duration of the dump phase (t_{dump}). If a free-running oscillator is available to generate a clock of sufficiently high frequency (i.e., f_{clk}>>1/t_{fill} and f_{clk}>>1/t_{dump}, where f_{clk} is the clock frequency), then a charge consumption monitor (or coulometer) can be implemented digitally via a simple counter (e.g., driven by the clock signal used in the control circuitry) that is enabled only during the appropriate time interval. For example, if one wishes to monitor the battery charge consumption of a boost mode supply, then the counter would only be enabled during the dump phase of each charging cycle. If, instead, the output charge consumption is of interest for a boost mode supply, then the counter would be enabled throughout both the fill and dump phases of each charging cycle. In either case, the net charge consumption Q_{consumed} over time would then be given by:
Q_{consumed}=(Iₚₑₐₖ/2)*(N/f_{clk})
where N is the count value.

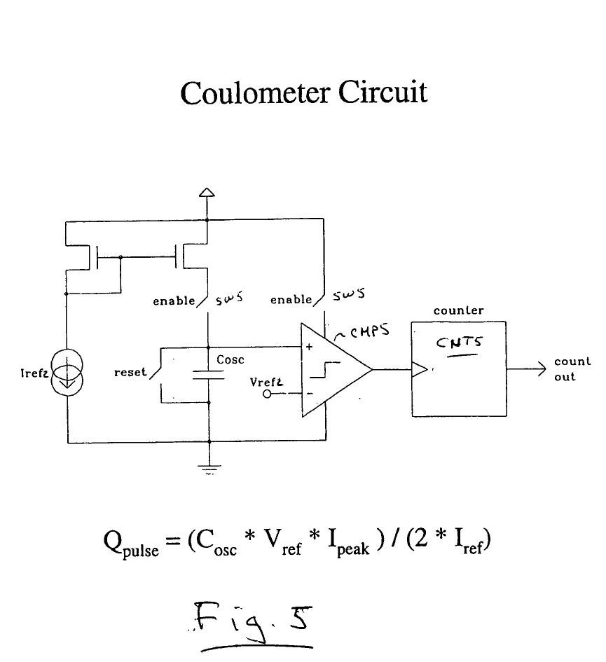

If a high-speed, free-running clock is not available, an alternate coulometer circuit can be realized using a relaxation oscillator that can be switched on and off quickly and can retain its phase within the oscillation cycle during the “off” state (this “phase memory” may be optional if the frequency of oscillation is sufficiently high). FIG. 5 illustrates this approach where the coulometer circuit includes a switchable relaxation oscillator with phase memory and a digital counter. The relaxation oscillator is essentially an analog timer that keeps track of the accumulated t_{fill}, t_{dump} or t_{fill}+t_{dump} time up to a specific time limit (ie. the free-run period). When this time limit is reached, an output pulse is generated and the timer is reset. In this manner, each output pulse from the relaxation oscillator represents a known quantity of accumulated t_{fill}, t_{dump} or t_{fill}+t_{dump} time and, as demonstrated above, also represents a known quantity of accumulated charge. A digital counter is then incremented for each output pulse received from the relaxation oscillator in order to maintain a running total of time (i.e., charge). As shown in FIG. 5, a simple relaxation oscillator can be built using a stable reference current I_{ref1}, a capacitor COSC, a stable reference voltage V_{fef2}, and a comparator CMP5. When the oscillator is enabled via switches SW5, the reference current charges up the capacitor at a fixed rate. The comparator then monitors the capacitor voltage against the reference voltage. When the capacitor voltage exceeds the reference voltage, the comparator output trips and the capacitor voltage is reset to zero again. The enable control for the relaxation oscillator consists of an input signal that asserts during the fill phase, the dump phase, or the fill and dump phases of the inductive supply charging cycle (depending on the power conversion mode and whether the battery vs. output charge consumption is of interest). These are the FPS, PKIC, and ZIC signals described above. The comparator output is then used to drive a digital counter CNT5. Each output pulse from the comparator corresponds to a quantity of charge Qₚᵤₗₛₑ calculated as:
Qₚᵤₗₛₑ=(C_{osc}*V_{ref}*Iₚₑₐₖ)/(2*I_{ref})
Since the reference current for the relaxation oscillator I_{ref2} and the reference current for the peak current detector _{Iref1} in the inductive switching regulator described above can both be derived from a common current reference, the accuracy of the coulometer is not affected by any inaccuracy in the current reference (assuming ideal current mirroring). Therefore, the only remaining sources of error in the resulting charge measurement are mismatch errors in the relaxation oscillator reference current and the peak current detector reference current due to current mirroring, offset errors in the peak current detector and zero current detector, errors in the reference voltage, errors in the capacitor value, turn-on and turn-off delays in the relaxation oscillator, capacitor reset delay, and battery and/or output voltage variations within a charging cycle that could cause the average inductor current to deviate from (Iₚₑₐₖ/2). These errors can be compensated for by applying a scalar calibration factor to the coulometer output. This scalar value can be obtained by comparing the uncalibrated coulometer measurement (monitored over a known time interval) against a current measurement made with a calibrated instrument.

Although the invention has been described in conjunction with the foregoing specific embodiments, many alternatives, variations, and modifications will be apparent to those of ordinary skill in the art. Such alternatives, variations, and modifications are intended to fall within the scope of the following appended claims.

1. A method for measuring charge consumption in a battery-powered electronic device having an inductive switching voltage regulator, wherein the inductive switching regulator alternately stores and discharges energy in an inductor in a two-phase power conversion cycle, the power conversion phases designated as fill and dump phases, respectively, such that the inductor current increases until a predetermined peak current value is reached during the fill phase and decreases to zero or other predetermined value during the dump phase, comprising:
measuring the duration of a power conversion phase during a power conversion cycle; and,
calculating the quantity of charge consumed during the power conversion cycle as the duration of the power conversion phase multiplied by one-half the peak inductor current.

2. The method of claim 1 further comprising:
measuring the cumulative duration of a power conversion phase over a plurality of power conversion cycles; and,
calculating the quantity of charge consumed during the plurality of power conversion cycles as the cumulative duration multiplied by one-half the peak inductor current.

3. The method of claim 1 wherein the inductive switching regulator is arranged in either a buck converter topology or a buck-boost converter topology and further comprising:
measuring the duration of the fill phase during a power conversion cycle; and,
calculating the quantity of battery charge consumption during the power conversion cycle as the duration of the fill phase multiplied by one-half the peak inductor current.

4. The method of claim 1 wherein the inductive switching regulator is arranged in a boost converter topology and further comprising:
measuring the duration of both the fill and dump phases during a power conversion cycle; and,
calculating the quantity of battery charge consumption during the power conversion cycle as the sum of the durations of the fill and dump phases multiplied by one-half the peak inductor current.

5. The method of claim 1 wherein the inductive switching regulator is arranged in either a boost converter topology or a buck-boost converter topology and further comprising:
measuring the duration of the dump phase during power conversion cycle; and,
calculating the quantity of output charge consumption during the power conversion cycle as the duration of the dump phase multiplied by one-half the peak inductor current.

6. The method of claim 1 wherein the inductive switching regulator is arranged in a buck converter topology and further comprising:
measuring the duration of both the fill and dump phases during a power conversion cycle; and,
calculating the quantity of output charge consumption during the power conversion cycle as the sum of the durations of the fill and dump phases multiplied by one-half the peak inductor current.

7. A power supply for an implantable medical device, comprising:
a battery;
an inductive switching voltage regulator connected to the battery for supplying a regulated voltage to the device, wherein the inductive switching voltage regulator alternately stores and discharges energy in an inductor in a two-phase power conversion cycle, the power conversion phases designated as fill and dump phases, respectively, such that the inductor current increases until a predetermined peak current value is reached during the fill phase and decreases to zero or other predetermined value during the dump phase; and,
a circuit for measuring charge consumption in the device by measuring the duration of a power conversion phase during a power conversion cycle, wherein the quantity of charge consumed during the power conversion cycle is the duration of the power conversion phase multiplied by one-half the peak inductor current.

8. The device of claim 7 wherein the charge consumption measuring circuit measures the cumulative duration of a power conversion phase over a plurality of power conversion cycles and calculates the quantity of charge consumed during the plurality of power conversion cycles as the cumulative duration multiplied by one-half the peak inductor current.

9. The device of claim 7 wherein the inductive switching regulator is arranged in either a buck converter topology or a buck-boost converter topology and further wherein the charge consumption measuring circuit measures the duration of the fill phase during a power conversion cycle and calculates the quantity of battery charge consumption during the power conversion cycle as the duration of the fill phase multiplied by one-half the peak inductor current.

10. The device of claim 7 wherein the inductive switching regulator is arranged in a boost converter topology and further wherein the charge consumption measuring circuit measures the duration of both the fill and dump phases during a power conversion cycle and calculates the quantity of battery charge consumption during the power conversion cycle as the sum of the durations of the fill and dump phases multiplied by one-half the peak inductor current.

11. The device of claim 7 wherein the inductive switching regulator is arranged in either a boost converter topology or a buck-boost converter topology and further wherein the charge consumption measuring circuit measures the duration of the dump phase during a power conversion cycle and calculates the quantity of output charge consumption during the power conversion cycle as the duration of the dump phase multiplied by one-half the peak inductor current.

12. The device of claim 7 wherein the inductive switching regulator is arranged in a buck converter topology and further wherein the charge consumption measuring circuit measures the duration of both the fill and dump phases during a power conversion cycle and calculates the quantity of output charge consumption during the power conversion cycle as the sum of the durations of the fill and dump phases multiplied by one-half the peak inductor current.

13. The device of claim 7 wherein the charge consumption measuring circuit comprises an oscillator and a counter driven by the oscillator, wherein the counter is enabled during one or more selected power conversion phases of the inductive switching voltage regulator.

14. The device of claim 7 wherein the charge consumption measuring circuit comprises:
a switchable relaxation oscillator;
a digital counter; and,
wherein the relaxation oscillator is enabled during one or more selected power conversion phases of the inductive switching voltage regulator and outputs pulses which drive the digital counter, each pulse corresponding to a certain quantity of charge consumed.

15. The device of claim 14 wherein the relaxation oscillator has a phase memory.

16. The device of claim 14 wherein the relaxation oscillator comprises:
a capacitor which is charged by a reference current;
a first comparator which monitors the capacitor voltage and outputs a pulse when the capacitor voltage exceeds a reference voltage.

17. The device of claim 14 wherein the inductive switching voltage regulator includes a second comparator for monitoring a voltage proportional to the inductor current so that the fill phase is terminated when the inductor current reaches the predetermined peak current value and further wherein the second comparator compares the voltage proportional to the inductor current with a reference voltage proportional to the reference current used to charge the capacitor of the relaxation oscillator.

18. An implantable cardiac rhythm management device, comprising:
sensing circuitry for sensing cardiac depolarizations;
therapy circuitry for delivering electro-stimulation to a heart chamber;
a controller for controlling the delivery of electro-stimulation;
a battery and an inductive switching voltage regulator connected to the battery for supplying a regulated voltage or voltages to the device, wherein the inductive switching voltage regulator alternately stores and discharges energy in an inductor in a two-phase power conversion cycle, the power conversion phases designated as fill and dump phases, respectively, such that the inductor current increases until a predetermined peak current value is reached during the fill phase and decreases to zero or other predetermined value during the dump phase; and,
a circuit for measuring charge consumption in the device by measuring the duration of a power conversion phase during a power conversion cycle, wherein the quantity of charge consumed during the power conversion cycle is the duration of the power conversion phase multiplied by one-half the peak inductor current.

19. The device of claim 18 wherein the charge consumption measuring circuit includes code executed by the controller for calculating the quantity of charge consumed during the power conversion cycle as the duration of the power conversion phase multiplied by one-half the peak inductor current.

20. The device of claim 19 wherein the charge consumption measuring circuit measures the cumulative duration of a power conversion phase over a plurality of power conversion cycles and calculates the quantity of charge consumed during the plurality of power conversion cycles as the cumulative duration multiplied by one-half the peak inductor current.
